(19) United States
(12) Patent Application Publication
(10) Pub. No.: US 2006/0093472 A1
(43) Pub. Date: May 4, 2006

(54) Blower structure

(76) Inventor: Hsiu Yin Chen, Fongyuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/978,397

(22) Filed: Nov. 2, 2004

(51) Int. Cl. F03B 3/06

(52) U.S. Cl. 415/129

(57) ABSTRACT

A blower structure including a housing having a wind outlet and two wind inlets formed on two sideboards of the housing. One of the sideboards has an outward extending bracket section on which a motor is fixed. An outer diameter of the motor is smaller than a diameter of the wind inlet, whereby the wind inlet can keep a suitable open area for taking in the air. A blower fan is disposed in the housing of the blower. The blower fan has a fixing disc with which an output shaft of the motor is connected. The fixing disc is positioned on one side of the blower fan proximal to the motor, whereby the output shaft has a suitable length. The blower structure has both advantages of short length of the output shaft of the motor and suitable wind intake.

### BACKGROUND OF THE INVENTION

The present invention is related to an improved blower structure in which the motor and the fixing disc of the blower fan are displaced in the same direction, whereby the blower structure has both advantages of short length of output shaft of the motor and suitable wind intake.

FIG. 2 shows a conventional blower including a housing 6 having a wind outlet 61. Two sideboards 62, 63 are respectively fixed on two sides of the housing 6. The sideboards 62, 63 respectively have two wind inlets 621, 631. A motor 7 is disposed on outer side of the sideboard 62. The motor 7 has an output shaft 71 extending through the wind inlet 621 to connect with a central fixing disc 72 of the blower fan 64. The motor 7 serves to drive the blower fan 64, making the air go from the wind inlets 621, 631 into the housing 6 and get out of the housing 6 from the wind outlet 61.

In order not to block the wind inlet 621, the motor 7 is arranged in a position distal from the wind inlet 621. Accordingly, the output shaft 71 of the motor 7 extends by a considerable length. Such elongated output shaft 71 tends to bend. As a result, during rotation, the blower fan 64 tends to eccentrically swing.

In order to overcome the above problems, an improved blower has been developed as shown in FIG. 3. The motor 8 is arranged at the wind inlet 811 of the sideboard 81 so as to shorten the distance between the fixing disc 84 of the blower fan 83 and the motor 8. That is, the length of the output shaft 82 of the motor 8 is shortened. This can avoid the problems of bending of the output shaft 82 and the eccentric swing of the blower fan. However, the motor 8 is fixed in the wind inlet 811 of the sideboard 81 to partially block the wind inlet 811. As a result, the area of the opening of the wind inlet 811 is minified so that the amount of incoming wind is reduced. This deteriorates the intake and exhaust effect of the blower.

### SUMMARY OF THE INVENTION

It is therefore a primary object of the present invention to provide an improved blower structure including a housing having a wind outlet and two wind inlets formed on two sideboards of the housing. One of the sideboards has an outward extending bracket section on which a motor is fixed. An outer diameter of the motor is smaller than a diameter of the wind inlet, whereby the wind inlet can keep a suitable open area for taking in the air. A blower fan is disposed in the housing of the blower. The blower fan has a fixing disc with which an output shaft of the motor is connected. The fixing disc is positioned on one side of the blower fan proximal to the motor, whereby the length of the output shaft will not be increased. Therefore, the blower structure has both advantages of short length of the output shaft of the motor and suitable wind intake.

According to the above object, the blower structure of the present invention includes a housing having a wind outlet and two wind inlets on two sides of the housing. A motor is fixed on one side of the housing. The motor has an axially extending output shaft connected with a blower fan. The blower fan is drivable by the motor to suck air from the wind inlets into the housing and exhaust the air from the wind outlet out of the housing. Two sideboards are respectively fixed on two sides of the housing. One of the sideboards has an outward extending bracket section on which the motor is fixed. An outer diameter of the motor is smaller than a diameter of the wind inlet, whereby the wind inlet can keep a suitable open area for taking in the air. The blower fan has a fixing disc with which an output shaft of the motor is connected. The fixing disc being positioned on one side of the blower fan proximal to the motor, whereby the output shaft has a suitable length.

The present invention can be best understood through the following description and accompanying drawings wherein:

### BRIEF DESCRIPTION OF THE DRAWINGS

FIG. 1 is a sectional view showing the structure of-the present invention;

FIG. 2 is a sectional view of a conventional blower; and

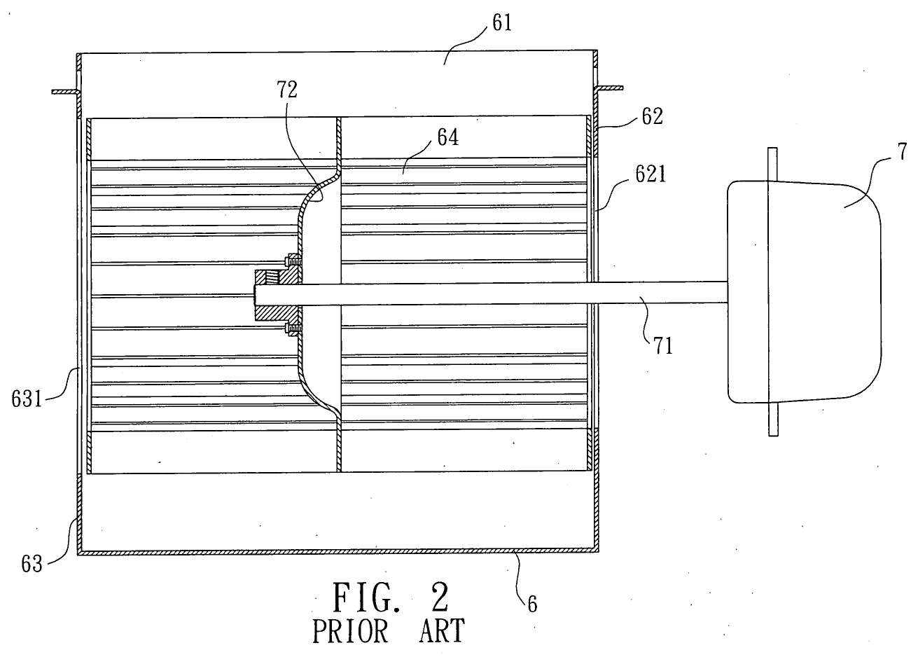

FIG. 3 is a sectional view of another type of conventional blower.

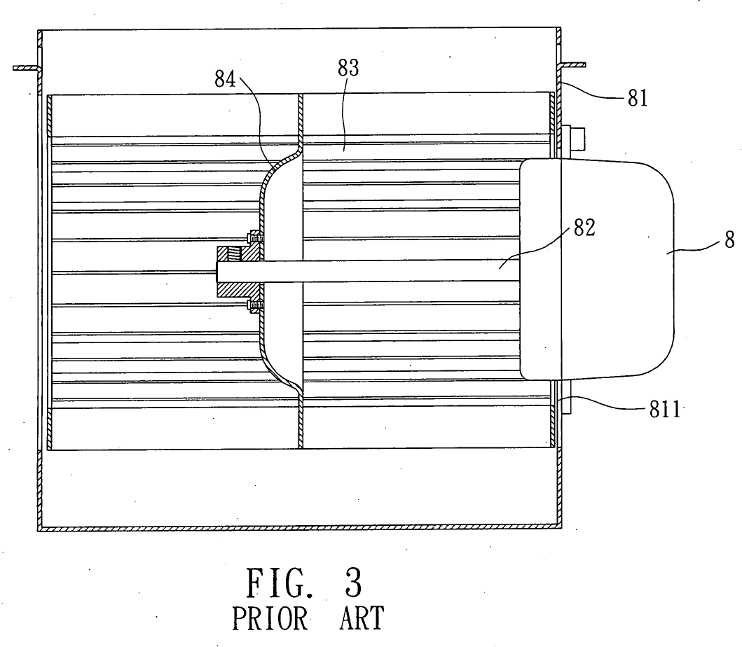

### DETAILED DESCRIPTION OF THE PREFERRED EMBODIMENT

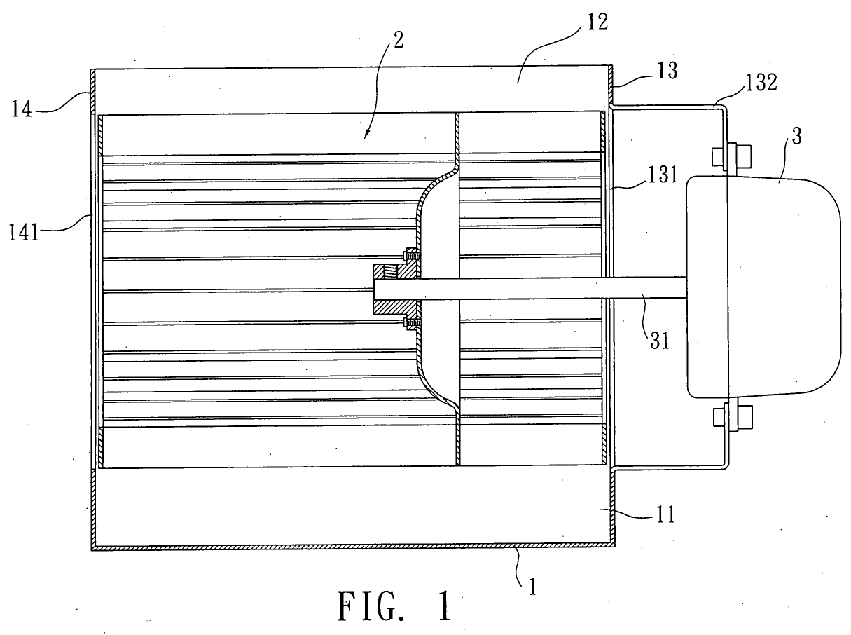

Please refer to FIG. 1. The blower of the present invention includes a housing 1 having an internal receiving space 11 in which a blower fan 2 is accommodated. The housing 1 has a wind outlet 12 communicating with the receiving space 11. Two sideboards 13, 14 are respectively fixed on two sides of the housing 1. The sideboards 13, 14 respectively have two wind inlets 131, 141 corresponding to the blower fan 2. The sideboard 13 has an outward extending bracket section 132 on which a motor 3 is fixed. The outer diameter of the motor 3 is smaller than the diameter of the wind inlet 131 so that the wind inlet 131 can keep a certain open area for taking in the air. The blower fan 2 has a fixing disc 21 with which an output shaft 31 of the motor 3 is connected. The fixing disc 21 is positioned on one side of the blower fan 2 proximal to the motor 3, whereby the output shaft 31 has a certain length.

The motor 3 is fixed on the bracket section 132 outward extending from the sideboard 13 so that the motor 3 is spaced from the wind inlet 131 by a certain distance. In addition, the outer diameter of the motor 3 is smaller than the diameter of the wind inlet 131 so that the wind inlet 131 can keep a certain open area for taking in the air. Therefore, the wind intake of the wind inlet will not be reduced as the conventional technique.

Moreover, the fixing disc 21 of the blower fan 2 is not disposed in the middle of the blower. Instead, the fixing disc 21 is disposed on one side of the blower fan 2 proximal to the motor 3. Therefore, the distance between the motor 3 and the fixing disc 21 is not elongated. Accordingly, the length of the output shaft 31 of the motor 3 will not be increased. Therefore, the problem of eccentric swing of the blower fan resulting from too long output shaft can be avoided. In other words, the blower structure of the present invention has both advantages of short length of output shaft 31 and suitable wind intake.

In conclusion, in the present invention, the motor 3 and the fixing disc 21 of the blower fan 2 are displaced in the same direction, whereby the blower structure of the present invention has both advantages of short length of output shaft 31 of the motor 3 and suitable wind intake.

The above embodiment is only used to illustrate the present invention, not intended to limit the scope thereof. Many modifications of the above embodiment can be made without departing from the spirit of the present invention.

What is claimed is:

1. A blower structure comprising a housing having a wind outlet and two wind inlets on two sides of the housing, a motor being fixed on one side of the housing, the motor having an axially extending output shaft connected with a blower fan, the blower fan being drivable by the motor to suck air from the wind inlets into the housing and exhaust the air from the wind outlet out of the housing, said blower structure being characterized in that two sideboards are respectively fixed on two sides of the housing, one of the sideboards having an outward extending bracket section on which the motor is fixed, an outer diameter of the motor being smaller than a diameter of the wind inlet, whereby the wind inlet can keep a suitable open area for taking in the air, the blower fan having a fixing disc with which an output shaft of the motor is connected, the fixing disc being positioned on one side of the blower fan proximal to the motor, whereby the output shaft has a suitable length.
